(19) United States
(12) Patent Application Publication
(10) Pub. No.: US 2002/0063519 A1
(43) Pub. Date: May 30, 2002

(54) Method for illumination and a portable electronic device

(75) Inventors: Kaisa Rikkinen, Tampere (FI); Kaj Saarinen, Turku (FI)

Correspondence Address: DARBY & DARBY P.C., 805 Third Avenue, New York, NY, 10022, US

(73) Assignee: NOKIA CORPORATION

(21) Appl. No.: 09/989,787

(22) Filed: Nov. 20, 2001

(30) Foreign Application Priority Data
Nov. 24, 2000 (FI) 20002593

(51) Int. Cl. H01J 1/62

(52) U.S. Cl. 313/506

(57) ABSTRACT

The invention relates to a method for illumination. In the method, the light source (1) used is an electroluminescent light source comprising at least two luminescent layers (L7, L9), and the color of light formed in at least two luminescent layers (L7, L9) is substantially the same when the light is emitted from the light source (1). The invention further relates to a portable electronic device comprising a light source (1), and to an electroluminescent light source (1) comprising a first (L7) and a second luminescent layer (L9), which are arranged to emit light of substantially the same color from the light source (1).

The present invention relates to a method for illumination. The invention further relates to a portable electronic device comprising a light source. The invention also relates to an electroluminescent light source comprising at least a first luminescent layer.

In portable electronic devices, such as wireless communication devices, liquid crystal displays (LCD) are commonly used as display devices. Since a liquid crystal display does not emit light, it must be illuminated, particularly when the ambient light is not sufficient for perceiving the presented information. In addition, the keyboard of the electronic device can be illuminated so that its keys could be perceived in poor lighting conditions. Typically a so-called electroluminescent light source (EL, electroluminescent lamp) is applied as a backlight used for illuminating the display and keyboard. Advantages of this electroluminescent light source are, among other things, that no separate photoconductors are needed, and that the electroluminescent light source is relatively thin. One problem with this sort of electroluminescent light source is the act of increasing the brightness level. The brightness of the electroluminescent light source can be amplified by increasing the control voltage and/or the frequency of the control voltage of the electroluminescent light source. However, these two measures for increasing the brightness have a negative effect on the life period of the electroluminescent light source. Moreover, the change in the brightness is not necessarily sufficient in embodiments where the light transmission of the LCD display element placed on the electroluminescent light source is poor. In that case it is, particularly in portable electronic devices, difficult to achieve a sufficient luminance for the backlight by using an electroluminescent light source.

The appended FIG. 1 shows a reduced cross section of the structure of a prior art electroluminescent light source used as a backlight. It is formed in a similar manner as a capacitor, that is, the electroluminescent light source comprises two conducting electrode layers L1, L2 and therebetween at least a non-conductive layer L3. In addition to these layers the electroluminescent display usually also comprises a luminescent phosphorus layer L4 between the transparent surface electrode layer L1 and the background electrode layer L2. Further, both layers have a protecting layer L5, L6, of which the surface layer L5 is at least partly transparent.

The electroluminescent light source operates as follows: When voltage is switched between the surface electrode layer L1 and the background electrode layer L2, it generates an electric field, wherein phosphorus atoms move to a higher energy level. After the electric field is switched off, the adjusted atoms return to a lower energy state, wherein photons are emitted from the atoms, which can be perceived as light. The wavelength of the emitted light is influenced for example by the phosphorus used in the electroluminescent light source and, to some extent, the frequency of the voltage. The increase in the frequency shifts the wavelength of the light slightly to the blue scheme. Different colors of electroluminescent light sources can be generated using different types of phosphorus, adding fluorescent colorants in the luminescent phosphorus layer L4 and/or using color filters on the light source.

In order to operate, an electroluminescent light source requires a relatively large operating voltage, typically top-to-top alternating voltage in the order of 160 V with the frequency of approximately 160 Hz. In connection with portable devices, such as wireless communication devices, this means that a voltage converter is required for changing a low direct voltage to a sufficiently high alternating voltage.

The electrode layer of electroluminescent light sources, which is at least partly transparent, is typically formed by sputtering. In prior art electroluminescent light sources this layer is typically composed of indium-tin oxide (ITO). Recently, however, methods have been developed for forming a transparent electrode layer by pressing, wherein the electrode layer has become more reliable and endurable, particularly against humidity. However, a drawback of this method is that it is more expensive than the sputtering method. On the other hand, the pressing method enables the manufacture of three-layered electroluminescent light sources, wherein a two-colored electroluminescent light source can be attained.

A purpose of the present invention is to bring about a method for illumination in such a manner that drawbacks of prior art can be reduced significantly. The invention is based on the idea of using an electroluminescent light source which comprises at least two luminescent layers and in which the color of light emitted by at least two luminescent layers is substantially the same. The method according to the present invention is characterized in that a light source is used, said light source is an electroluminescent light source that comprises at least two luminescent layers, and the color of light produced in at least two luminescent layers is substantially the same when the light is emitted from the light source. The portable electronic device according to the present invention is characterized in that the light source is an electroluminescent light source comprising at least two luminescent layers, and that at least two luminescent layers are arranged to emit light of substantially the same color from the light source. Further, the electroluminescent light source according to the present invention is characterized in that the electroluminescent light source further comprises at least a second luminescent layer and that at least two luminescent layers are arranged to emit light of substantially the same color from the electroluminescent light source.

The present invention shows remarkable advantages when compared to solutions of prior art. Using the method of the invention, twice as strong a luminance can be attained for the electroluminescent light source when compared to prior art luminescent light sources. In order to produce a corresponding luminance using prior art methods and electroluminescent light sources, either the frequency of the operating voltage and/or the operating voltage should be increased to a higher level than in the solution of the invention. In the solution of the invention, in which backlight is produced using only a number of layers necessary at the time, for example one or two layers, it is possible to affect the power consumption of the device while the brightness of the backlight always stays at the best possible level in relation to the illumination of the surrounding space. In a situation where maximum luminance is not required for the backlight, it is possible to change the luminescent layer, wherein the operating life of the electroluminescent light source can be lengthened compared to a situation where the same luminescent layer is always used for illumination.

In the following, the invention will be described in more detail with reference to the appended drawings, in which

FIG. 1 shows a prior art electroluminescent light source in a reduced cross section,

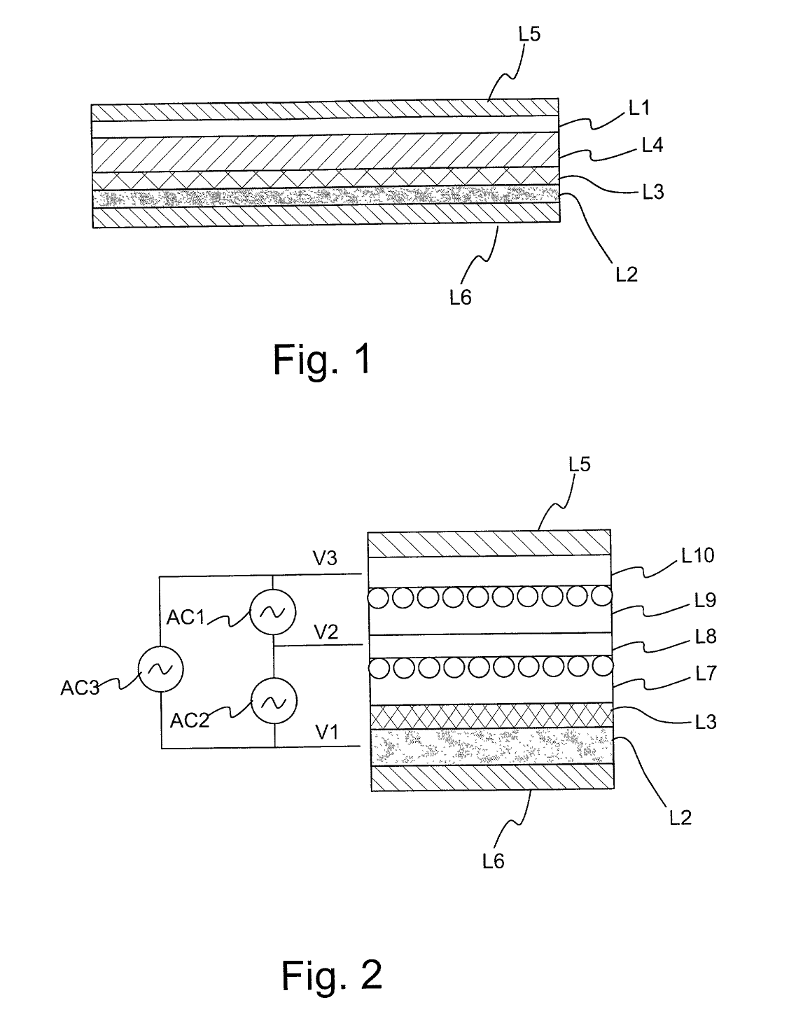

FIG. 2 shows an electroluminescent light source according to an advantageous embodiment in a reduced cross section,

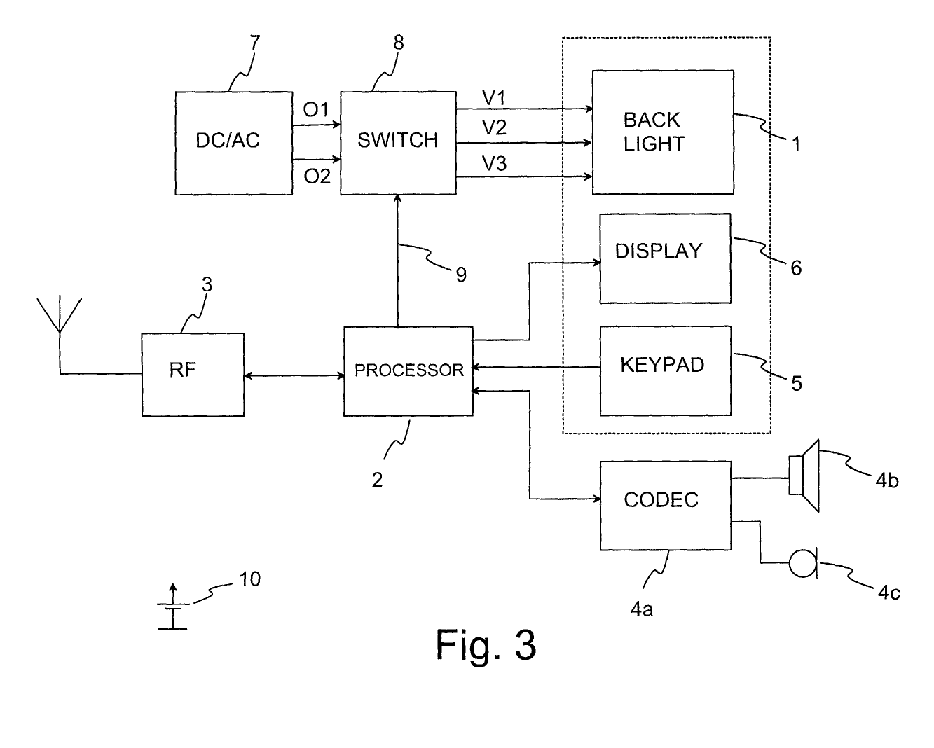

FIG. 3 shows a portable electronic device according to an advantageous embodiment of the invention in a reduced block chart, and

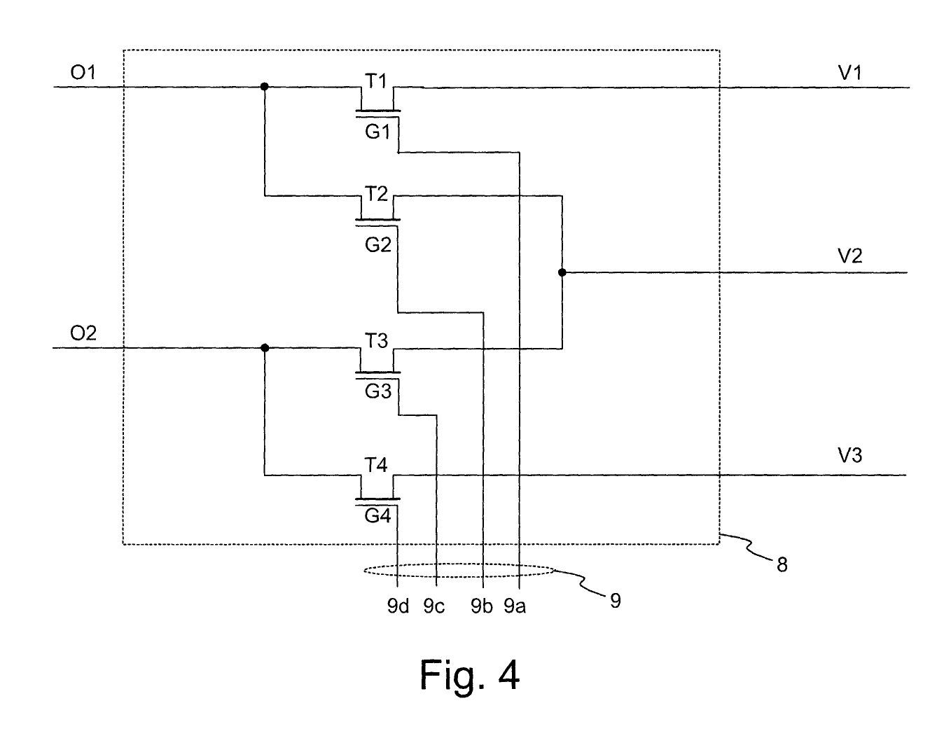

FIG. 4 shows in a reduced manner a voltage controller used in a portable electronic device according to an advantageous embodiment of the invention.

The appended FIG. 2 shows, in a reduced cross-section, the structure of an electroluminescent light source 1 complying with a preferred embodiment of the invention. It comprises a protective layer L6, which is covered with a background electrode L2 and a non-conductive layer L3. On top of this non-conductive layer, a first luminescent layer L7 is arranged, and on top of it, a first electrode layer L8, which is at least partly transparent. On top of this is placed a second luminescent layer L9 and an at least partly transparent second electrode layer L10. The topmost layer in this structure is formed by a protective layer L5, such as a polyethylene film (PET). In addition, a controlling principle of the luminescent light source according to an advantageous embodiment of the present invention is marked in the appended FIG. 2 as voltage sources AC1, AC2, AC3. In a situation where operating voltage is supplied to the first electrode layer L8 and the second electrode layer L10, the second luminescent layer L9 emits light whose color is mainly defined by the phosphorus type of this second luminescent layer. This situation is illustrated in FIG. 2 with a first operating voltage source AC1. If operating voltage is supplied to the background electrode L2 and to the first electrode layer L8, the first luminescent layer L7 emits light whose color is mainly defined by the phosphorus type of this first luminescent layer. This is illustrated by a second operating voltage source AC2 in the appended FIG. 2. These first L7 and second luminescent layers L9 preferably use the same type of phosphorus, wherein it is attained that both luminescent layers L7, L9 emit light of a substantially same color. Consequently, the brightness of the luminescent light source can be increased by implementing light emission both in the first L7 and the second luminescent layer L9. This can be carried out in the following way. The operating voltage (marked in the figure as a third operating voltage source AC3) is supplied to a background electrode L2 and a second electrode layer L10, wherein the electroluminescent light source emits light that is a combination of the first luminescent layer L7 and the second luminescent layer L9, which in this situation means light of the same color and with a luminance that is approximately twice as strong as the luminance of the light emitted by one luminescent layer. Using the references of FIG. 2, the first luminescent layer L7 and the second luminescent layer L9 are produced of substantially same materials. The transparent electrode layers L8, L10 are formed in the electroluminescent light source 1, preferably by pressing.

In the following, the operation of a portable electronic device MS according to a preferred embodiment of the invention, as illustrated in FIG. 3, will be described. The portable electronic device MS comprises preferably a processor 2, a radio part 3, audio apparatus, such as a codec 4a, a speaker/earpiece 4b and a microphone 4c, a keyboard 5, and a display 6. Further, the portable electronic device MS comprises illumination means for advantageously illuminating the display 6 and/or the keyboard 5, when necessary. This apparatus for illumination preferably comprises an electroluminescent light source 1, a voltage converter 7 and a voltage controller 8. The electroluminescent light source 1 comprises at least two light-emitting layers in such a manner that in at least two of these light emitting-layers such material is used that substantially emits light of the same color. Preferably, the same material, such as phosphorus, is used in these layers L7, L9.

The voltage converter 7 is used to produce the operating voltage of the electroluminescent light source 1 from the operating voltage source, such as a battery 10, of the portable electronic device MS, the operating voltage being alternating voltage with a top-to-top amplitude of typically 160 V and frequency of about 160 Hz. By means of the voltage controller 8 this operating voltage of the electroluminescent light source 1 can be coupled to the operating voltage lines V1, V2, V3 of the electroluminescent light source 1 in a manner appropriate at the time. In a situation when the light of the light source is not used, the operating voltage is not connected to the electroluminescent light source 1. Consequently, the voltage converter 7 can also be switched off if necessary. When the light should be as bright as possible, the portable electronic device MS according to a preferred embodiment of the invention is implemented as follows. The processor 2 controls the voltage controller 8 in such a way that the operating voltage generated by the voltage converter 7 is coupled to the first operating voltage line V1 and the third operating voltage line V3 of the electroluminescent light source 1. This first operating voltage line V1 is coupled to the background electrode L2 of the electroluminescent light source. In a corresponding manner, the third operating voltage line V3 is coupled to the second electrode layer L10 of the electroluminescent light source L1. Consequently, in the electroluminescent light source 1 the first luminescent layer L7 emits light and the second luminescent layer L9 emits light of a substantially same color as the first luminescent layer. Consequently, the luminance of the electroluminescent light source is approximately twice as strong as the intensity of light generated by one luminescent layer L7, L9. To attain corresponding luminance using prior art methods and electroluminescent light sources, either the frequency of the operating voltage and/or the operating voltage should be increased higher than in the solution of the present invention. In a situation where maximum luminance is not required for the backlight, it is possible, using a voltage controller, to couple the operating voltage for example between the background electrode L2 and the first transparent electrode layer L8 wherein only the first luminescent layer L7 emits light, or between the first transparent electrode layer L8 and the second transparent electrode layer L10 wherein only the second luminescent layer L9 emits light. Moreover, in such a situation it is possible to alternate the operating voltage between the background electrode L2 and the first transparent electrode layer L8 and between the first L8 and the second L10 transparent electrode layer. Consequently, the luminance is substantially half of the maximum value, but because both luminescent layers L7, L9 are used for light emission periodically, the operating life of the electroluminescent light source 1 can be increased, when compared to a situation in which the same luminescent layer is always used for illumination.

The voltage converter 7 can be a voltage converter known per se, wherein from the operating voltage source of the portable electronic device a sufficiently high alternating voltage can be generated as an operating voltage of the electroluminescent light source 1. Furthermore, the structure of this voltage converter is prior art known by anyone skilled in the art, wherein it is not necessary to describe it in more detail in this context.

The voltage controller 8 preferably comprises semiconductor switches, such as MOSFET transistors, by means of which a first output voltage line 01 and a second output voltage line 02 of the voltage converter can be coupled in required combinations to the operating voltage lines V1, V2, V3 of the electroluminescent light source 1. The position of these switches is controlled by lines of a control bus 9, preferably in binary signals. The appended FIG. 4 shows, in a reduced manner, one advantageous embodiment of the structure of this voltage controller 8. The voltage controller 8 comprises four transistors T1, T2, T3, T4, which are preferably MOSFET transistors. These transistors should resist at least a voltage corresponding to the operating voltage of the electroluminescent light source 1. In this embodiment, these transistors T1 to T4 are used as switches. The control data is transferred to gates G1 to G4 of these transistors using lines 9a to 9d of the control bus 9, for example in a manner that the first control line 9a controls the first transistor T1, the second control line 9b controls the second transistor T2, the third control line 9c controls the third transistor T3, and the fourth control line 9d controls the fourth transistor T4. In a situation where the aim is to switch the operating voltage to the first electrode L8 and the second electrode L10, the transistor T2 and the transistor T4 are preferably set to be conductive, wherein the first voltage line 01 of the voltage converter is coupled to the second operating voltage line V2 of the electroluminescent light source 1 and, correspondingly, the second voltage line 02 of the voltage converter is coupled to the third operating voltage line V3 of the electroluminescent light source 1. The data transmitted via lines 9a to 9d of the control bus 9 is preferably binary data, wherein the value of each bus can be either the logic 0 or the logic 1. The logic 0, for example, corresponds to a voltage value of approximately 0 volt, and, correspondingly, the logic 1 preferably corresponds approximately to a respective voltage value of the operating voltage of the portable electronic device MS, this value being for example 3 V. This control bus 9 is coupled advantageously to interface lines of the processor, which is prior art known as such by anyone skilled in the art. It is obvious that the afore-described structure of a voltage controller 8 is only an example, and in practical embodiments other implementations for voltage controls can also be used.

Various criteria can be used for switching the light source 1 on and off. The portable electronic device MS can comprise for example a light-sensitive sensor for measuring the ambient light. Consequently, in case the illumination of the surrounding space falls below a predefined value, the light source is switched on, for example with the first luminance, when the user presses the keyboard keys or, for example in the case of an incoming call. The light makes it easier for the user to better recognize the information shown on the display 6, for example to recognize where the call is coming from. In addition, it is possible to define a second threshold value for the illumination, wherein when the ambient light falls below this second threshold value, the light produced by the light source is set to the second luminance value applying the method of the preferred embodiment of the invention, wherein at least two luminescent layers L7, L9 of the electroluminescent light source 1 emit light. To switch off the light source, for example a delay can be used, wherein the light source is switched off after a certain time has passed since the keyboard has been pressed and/or a call has ended. In addition, the portable electronic device MS can comprise several electroluminescent light sources according to the preferred embodiment of the invention, wherein for example a separate light source has been arranged for the display 6 and the keyboard 5. Consequently, these light sources of the keyboard 5 and the display 6 can be controlled separately, and for example the user can in the settings of the portable electronic device define which light sources are used when necessary. The actions required for controlling the electroluminescent light source 1 of the invention can be implemented advantageously as program commands of the processor 2 of the portable electronic device.

The light generated by the light source 1 is used in portable electronic devices advantageously as a so-called backlight, but it is obvious that the incoming direction of the light to the object that is illuminated is irrelevant in view of the present invention. The light can also come for example from the side of the object to be illuminated. In some embodiments photoconductors can also be used, whereby the light generated by the light source is conducted to the object to be illuminated from a desired direction.

In a method of another advantageous embodiment of the invention, socalled conversion agents are used in one or several luminescent layers L7, L9 of the electroluminescent light source. These conversion agents generate a color change, either in the luminescent layer itself, or in a situation where light produced by one luminescent layer is directed through another luminescent layer. As an example, white light can be produced of a cyan phosphorus/electroluminescent light source by adding an appropriate conversion agent on the surface of a luminescent layer L7, L9. In a corresponding manner, using symbols of FIG. 2, if the light spectrum produced by the first luminescent layer L7 changes when it penetrates the second luminescent layer L9, this color change is considered in the formation of the first luminescent layer L7. Consequently, in the first luminescent layer L7, such conversion agent is used by which the color of the light produced by the first luminescent layer L7 changes into the substantially same color as the color of the light produced by the second luminescent layer L9 when penetrating the second luminescent layer L9. In a corresponding manner, if the electroluminescent light source comprises more than two luminescent layers L7, L9, the color changes caused by higher luminescent layers are considered in the composition of lower luminescent layers.

Even though the above-described illumination principle utilizes an electroluminescent light source, the invention can be applied to other light sources operating on the same principle.

It is obvious that the invention is not limited solely to the above-presented embodiments, but it can be modified within the scope of the appended claims.

1. Method for illumination, wherein a light source is used, said light source is an electroluminescent light source that comprises at least two luminescent layers, and the color of light produced in at least two luminescent layers is substantially the same when the light is emitted from the light source.

2. The method according to claim 1, wherein in at least two luminescent layers the same agent is used as light emitting agent.

3. The method according to claim 1, wherein at least the light produced in the first luminescent layer is directed through the second luminescent layer, that at least said second luminescent layer generates a change in the color generated by the first luminescent layer, wherein at least in said first luminescent layer a conversion agent is used, by means of which the color of the light generated by said first luminescent layer changes after penetrating said second luminescent layer, into substantially the same as the color that can be generated in said second luminescent layer.

4. The method according to claim 1, wherein the light generated by the light source is used for illuminating a display.

5. The method according to claim 1, wherein the light generated by the light source is used for illuminating a keyboard.

6. The method according to claim 1, wherein the intensity of the light generated by the light source is adjusted using one or several luminescent layers in illumination.

7. The method according to claim 6, wherein the illumination around the portable electronic device is determined, and the adjustment of the light intensity is performed automatically on the basis of the illumination of the surrounding space.

8. A portable electronic device comprising a light source, wherein the light source is an electroluminescent light source comprising at least two luminescent layers, and that at least two luminescent layers are arranged to emit light of substantially the same color from the light source.

9. The portable electronic device according to claim 8, wherein in at least two luminescent layers the same agent has been used as a light emitting agent.

10. The portable electronic device according to claim 9, wherein said at least two luminescent layers are made of phosphorus.

11. The portable electronic device according to claim 8, comprising a display, wherein the light source is arranged to illuminate the display.

12. The portable electronic device according to claim 8, comprising a keyboard, wherein the light source is arranged to illuminate the keyboard.

13. The portable electronic device according to claim 8, wherein it is a wireless communication device.

14. An electroluminescent light source comprising at least a first luminescent layer, wherein the electroluminescent light source further comprises at least a second luminescent layer and that at least two luminescent layers are arranged to emit light of substantially the same color from the electroluminescent light source.

15. The electroluminescent light source according to claim 14, characterized in that it comprises at least a first (L8) and a second electrode layer (L10), a background electrode (L2), and means (V1, V2, V3) for conducting operating voltage to said background electrode (L2) and to said first (L8) and second electrode layer (L10), that said first luminescent layer (L7) is placed between said first electrode layer (L8) and said background electrode (L2), and that said second luminescent layer (L9) is placed between said first (L8) and second electrode layers (L10).
